(19) United States
(12) Patent Application Publication
(10) Pub. No.: US 2007/0284861 A1
(43) Pub. Date: Dec. 13, 2007

(54) Gas bag module for a vehicle occupant restraint system

(75) Inventors: Matthias Helmstetter, Aschaffenburg (DE); Michael Lehmann, Aschaffenburg (DE); Marcus Magoley, Aschaffenburg (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/810,770

(22) Filed: Jun. 7, 2007

(30) Foreign Application Priority Data
Jun. 12, 2006 (DE) 20 2006 009 197.1

(51) Int. Cl. B60R 21/239

(52) U.S. Cl. 280/739

(57) ABSTRACT

A gas bag module adapted for use in a vehicle occupant restraint system comprises an inflatable gas bag and a discharge opening associated with the gas bag, so that gas can flow off from the gas bag which is fully or partially inflated. Further, the module comprises a discharge control element to control an opening cross-section of the discharge opening. The discharge control element contains a dilatant material.

### TECHNICAL FIELD OF THE INVENTION

The invention relates to a gas bag module for a vehicle occupant restraint system.

### BACKGROUND OF THE INVENTION

Vehicle occupant restraint systems with a gas bag module are known very well from the prior art. As the gas volume which is provided for inflating the gas bag provided in the gas bag module is dependent on unforeseeable environmental conditions such as air pressure and temperature, and as the vehicle occupant is not to rebound from the inflated gas bag, but rather is to experience an absorbing effect, discharge openings were already provided early on in the gas bag or in a fixed component of the gas bag module. However, gas already flows off during the inflation process in the case of discharge openings which are constantly open. The time up to the complete unfolding of the gas bag therefore becomes longer, and larger gas generators are necessary in order to additionally release the gas which has flowed out in the initial phase.

Recently, attempts have been made in a variety of ways to construct discharge openings the cross-section of which is variable. Generally, the internal pressure of the gas bag here is coupled proportionally in some kind of way to the discharge cross-section. As optimum a restraining as possible of the vehicle occupant is to be achieved with these variable discharge openings.

However, the optimum restraint conditions of a vehicle occupant depend here very much on the weight of the vehicle occupant. Known restraint systems therefore already provide load sensors in a vehicle seat or devices to determine the sitting position. These systems are all very complex and entail high costs accordingly.

DE 196 33 883 A1 shows a vehicle occupant restraint system which is significantly less complex and nevertheless has a variable outflow opening in the gas bag. The cross-section of the discharge opening here is primarily dependent on the stresses within a gas bag wall of the gas bag and hence on the internal pressure of the gas bag, but thereby also takes into account to a certain extent an occupant's weight. Gas bag materials are still required for this which have different expansibilities, special seams and/or cover flaps which must be sewn onto the gas bag wall.

It is an object of the present invention to achieve a further simplified adaptive control of the discharge cross-section of a gas bag module, which depends principally on the weight and/or the impact impulse of the occupant.

### SUMMARY OF THE INVENTION

A gas bag module for a vehicle occupant restraint system is provided according to the invention, which comprises an inflatable gas bag and a discharge opening associated with the gas bag, so that gas can flow off from the gas bag which is fully or partially inflated, and which additionally comprises a discharge control element to control an opening cross-section of the discharge opening, characterized in that the discharge control element contains a dilatant material.

Dilatant materials are materials the viscosity of which increases with the shear rate or shearing stress. They therefore display a contrary behaviour to pseudoplastic materials. Known examples for dilatant or “shear thickening” materials are mixtures of corn starch and water or a silicone plastic clay marketed as Silly Putty™ by Dow Chemicals which is mainly composed of a polydimethylsiloxane. According to the invention, this characteristic of dilatant materials is utilized to provide a self-regulating dynamic discharge opening. In the case of a high stressing of the gas bag, for example as a result of the impact of a heavy vehicle occupant, the internal pressure in the gas bag increases. However, the opening cross-section of the discharge opening remains small, because the dilatant material becomes harder owing to the higher forces acting on the discharge control element. In this way, an excess widening of the opening cross-section of the discharge opening with an increasing internal pressure in the gas bag is ruled out. The gas bag is therefore harder and the heavy vehicle occupant can therefore be reliably prevented from penetrating onto hard parts of the vehicle.

In the case of the impact of a lighter vehicle occupant, on the other hand, the dilatant material in the discharge control element is softer owing to the lower stressing of the gas bag, and the opening cross-section of the discharge opening becomes larger. Since therefore more gas can escape from the gas bag, the gas bag becomes softer and rebounding of the light vehicle occupant striking onto the gas bag is ruled out.

In a first embodiment, the discharge opening is arranged with the discharge control element in the gas bag, preferably to the side of the vehicle occupant who is impinging onto the inflated gas bag. It is particularly preferable for the discharge opening to be formed in a plastic membrane, particularly a silicone membrane, which is fastened to the gas bag wall by a seam connection or an adhesive connection. The discharge control element with the dilatant material can be introduced into the plastic membrane and can surround the discharge opening in the form of a ring. In particular, the plastic membrane can encase the dilatant material in the form of a tube. In this way, a simply constructed discharge opening is provided, which makes it possible to control the discharge cross-section as a function of the weight or the impact energy of the vehicle occupant, without an additional sensor arrangement.

In a further embodiment, the discharge opening and the discharge control element with the dilatant material are not provided in the gas bag wall, but rather in a steering wheel or a fixed component of the gas bag module. This component may be a carrier part or frame part of the gas bag module or a covering. However, the discharge opening and the discharge control element are constructed substantially as already described in connection with the first embodiment.

### BRIEF DESCRIPTION OF THE DRAWINGS

Further advantages of the invention will be apparent from the following description of a preferred embodiment and from the enclosed drawings, to which reference is made, in which:

FIG. 1 shows a top view onto the gas bag of a gas bag module according to the invention;

FIG. 2 shows a sectional view along the line 2-2 of FIG. 1;

FIG. 3 shows a gas bag according to the invention in the unfolded state;

FIG. 4 shows the gas bag of FIG. 3 in the case of stress, and

FIG. 5 shows a gas bag module, with the discharge control element being provided in a frame part.

### DETAILED DESCRIPTION OF THE INVENTION

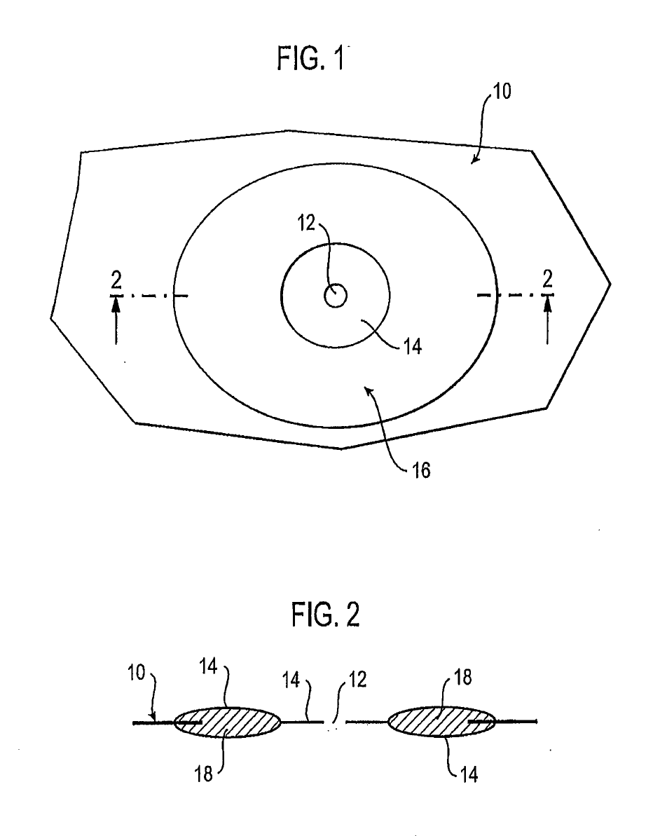

FIGS. 1 and 2 schematically show the wall section of a component 10 with a discharge opening 12, which is circular here, which is closed at least partially by a plastic membrane 14, for example of silicone. The discharge opening 12 and the plastic membrane 14 are surrounded in a ring shape by a discharge control element 16 which contains a dilatant material 18. In the embodiment shown here, the dilatant material 18 is encased in the form of a tube by the plastic membrane 14. The discharge control element 16 is therefore introduced into the plastic membrane 14. The plastic membrane 14 is fastened at its edges lying opposite the discharge opening 12 to the wall of the component 10 by a seam connection or adhesive connection.

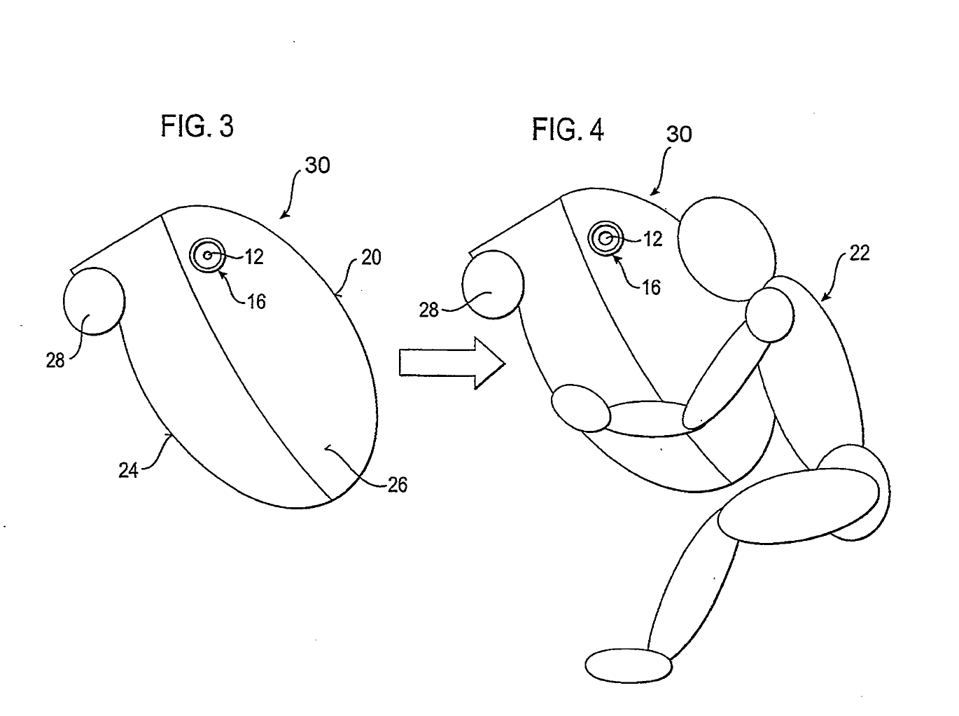

A gas bag 30 is shown in FIG. 3, which has been filled with gas from the gas generator of a gas bag module 28, illustrated diagrammatically, and in so doing has unfolded from the module. Independently of the blanks from which the gas bag 30 is formed, the wall of the gas bag 30 can be divided into a front wall section 20, which constitutes a primary impact surface for a vehicle occupant 22, and an opposite, rear wall section 24 and lateral wall sections 26 lying therebetween.

A discharge opening 12 with a discharge control element 16 of the type described above is provided in an upper region of the gas bag 30 in one of the lateral wall sections 26.

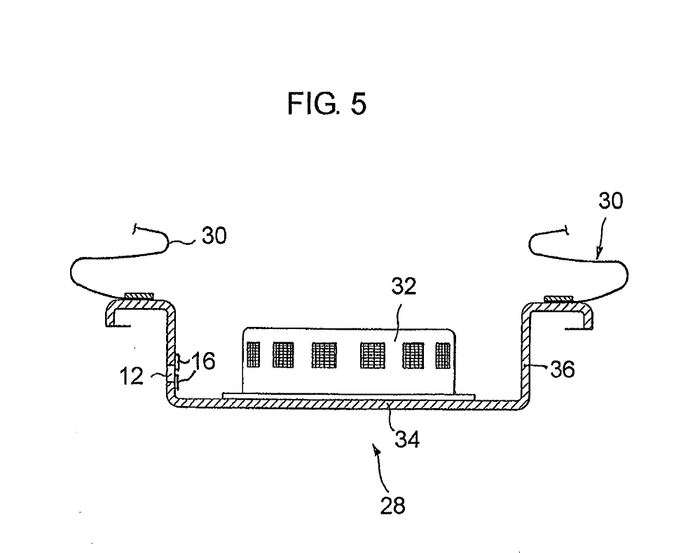

A further embodiment of the gas bag module according to the invention is illustrated in FIG. 5. This embodiment includes a gas generator 32 fixed to a carrier plate 34 of the gas bag module 28. The rims of the carrier plate 34 are bended up to form a frame part 36, which holds the gas bag 30 in a usual manner. The carrier plate 34 and the frame part 36 can be formed integrally with each other, as shown in FIG. 5. However, they can also be formed of separate components. A discharge opening 12 is formed in a wall section of the frame part 36 and is at least partially covered by the discharge control element 16. The discharge control element 16 can be formed as shown in FIGS. 1 and 2, and may be applied on the inner side of the wall section of the frame part 36. Further, it is possible that the discharge control element 16 with the dilatant material 18 contained therein is incorporated into the wall section of the frame part 36. Preferably, the discharge control element 16 is integrally formed with the wall section of the frame part 36. As an alternative to the embodiment shown in FIG. 5, the discharge control element 16 can be arranged on the outer side of the frame part 36. Finally, the discharge opening 12 together with the discharge control element 16 can also be arranged in the carrier plate 34 or in every other part of the gas bag module 28, for example in a module cover, which is however not shown.

The gas bag module illustrated in FIG. 5 is provided for being arranged in a vehicle steering wheel. Accordingly, the discharge control element 16 can also be placed in the steering wheel, wherein it is in fluid connection with the gas bag module.

In all embodiments, when the gas bag 30 is stressed by the impacting vehicle occupant 22, the internal pressure in the gas bag 30 rises considerably. The opening cross-section of the discharge opening 12 thereby increases. The size of the opening cross-section here is dependent on the intensity of the impact, which is affected inter alia by the weight of the vehicle occupant 22.

As the dilatant material 18 in the discharge control element 16 becomes harder as the stress increases, the opening cross-section of the discharge opening 12 is smaller with the impingement of a heavy vehicle occupant than with the impingement of a lighter vehicle occupant 22. Therefore, less gas can flow out from the gas bag per unit of time. This brings about the desired effect that the gas bag is harder with the impact of a heavy person or a greater impact impulse than with a light person or a smaller impact impulse. The heavy occupant is therefore prevented from penetrating onto the instrument panel, and light occupants are prevented from rebounding from a gas bag which is too hard and being thrown back.

1. A gas bag module adapted for use in a vehicle occupant restraint system, comprising an inflatable gas bag and a discharge opening associated with the gas bag, so that gas can flow off from the gas bag which is fully or partially inflated, and further comprising a discharge control element to control an opening cross-section of the discharge opening, wherein the discharge control element contains a dilatant material.

2. The gas bag module according to claim 1, wherein the discharge control element with the dilatant material surrounds the discharge opening in the form of a ring.

3. The gas bag module according to claim 1, wherein the discharge control element comprises a plastic membrane surrounding the discharge opening, and the dilatant material is introduced into the plastic membrane.

4. The gas bag module according to claim 3, wherein the plastic membrane encases the dilatant material in the form of a tube.

5. The gas bag module according to claim 3, wherein the plastic membrane is a silicone membrane.

6. The gas bag module according to claim 1, wherein the discharge opening and the discharge control element are formed in the gas bag.

7. The gas bag module according to claim 6, wherein the discharge control element is fastened to the gas bag by a seam connection or an adhesive connection.

8. The gas bag module according to any of claim 1, wherein the discharge opening and the discharge control element are formed in a fixed component of the gas bag module, the fixed component being selected from the group of a carrier part, a frame part and a covering.

9. The gas bag module of claim 1, wherein the discharge opening and the discharge control element are formed in a steering wheel.
